(19) United States
(12) Patent Application Publication
(10) Pub. No.: US 2002/0096527 A1
(43) Pub. Date: Jul. 25, 2002

(54) No-waste paint bucket with brush caddy

(76) Inventors: Louis C. Arenas, Santa Clara, CA (US); Todd Elliot Lewis, Mt. View, CA (US)

Correspondence Address: Louis C. Arenas, 1475 Las Palmas Dr., Santa Clara, CA, 95051, US

(21) Appl. No.: 09/769,079

(22) Filed: Jan. 22, 2001

(51) Int. Cl. B05C 21/00; B65D 25/00; B65D 90/00; B65D 1/40; B65D 3/28

(52) U.S. Cl. 220/570; 220/697; 220/699; 220/736

(57) ABSTRACT

A low-cost, stackable, ergonomic paint container includes a main reservoir for paint and an integral brush caddy. Structural provisions help prevent the waste of paint; prevent spillage of paint around the rim of the paint container; Inhibit contamination of the brush handle by dripping paint; and allow for ease of handling with one hand.

### FIELD OF THE INVENTION

The invention relates to a paint container that prevents the waste of paint, prevents spillage of paint around the rim of the paint container and allows for ease of handling with one hand.

### BACKGROUND OF THE PRIOR ART

There has been little innovation in the field of paint containers. The typical drawbacks to conventional “paint buckets” include (i) the waste of paint that spills over the bucket rim by wiping the brush against the bucket rim; (ii) the contamination of the paint bucket and surroundings by spillage of paint over the bucket rim; (iii) the contamination of the brush handle by dripping paint when no provisions are made for resting the paint brush in a suitable location on or about the paint bucket; and (iv) the ergonomic inadequacies of traditional paint bucket designs.

### BRIEF DESCRIPTION OF THE DRAWINGS

FIG. 1 is a perspective view of an exemplary paint container of the present invention.

FIG. 2 is top view of the paint container of FIG. 1.

FIG. 3 is a first sectional view of the paint container of FIG. 1.

FIG. 4 is a second sectional view of the paint container of FIG. 1.

FIG. 5 is a perspective view of an alternative embodiment of paint container of the present invention.

FIG. 6 is a perspective view of another embodiment of paint container .

### DETAILED DESCRIPTION OF THE INVENTION

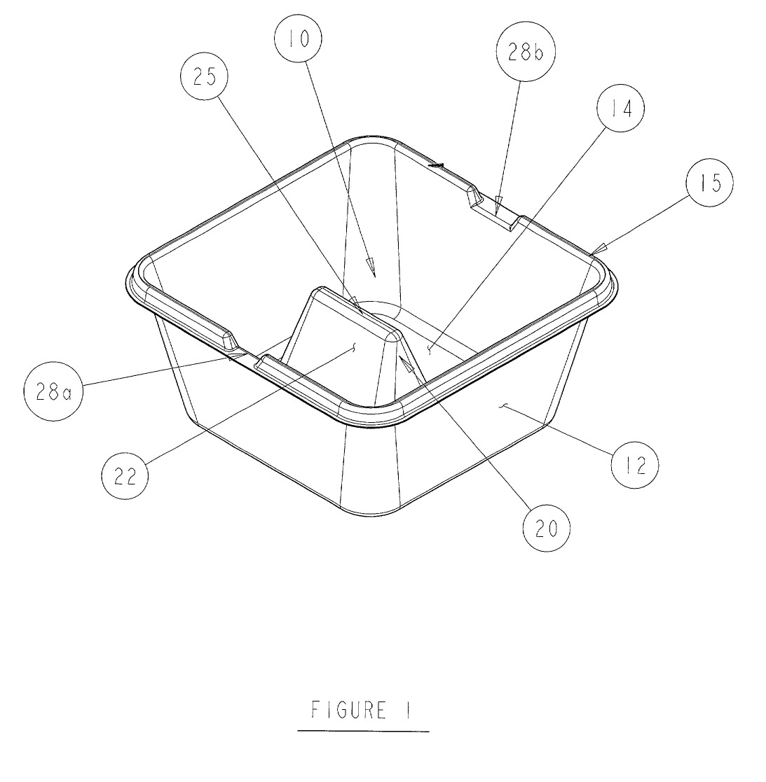

FIG. 1 illustrates a pre f erred embodiment of paint container body 10 of the present invention for preventing paint waste, for maintaining a clean rim about the paint container, and for ease of handling by the painter. The paint container has canted sides 12 that allow for verticle stacking of the paint containers. As can be seen in FIG. 1, the unitary body of the paint container is molded from any suitable plastic. The main body has a bottom wall portion 14 that transitions to the perimeter side wall portions 12. The open top of the container is surrounded by a perimeter rim indicated at 15.

The main body 10 of the paint container further provides a secondary body portion 20 that comprises intermediate wall portions 22 extending upward from the bottom wall portion 14. The top or upper portion of the intermediate wall portions form a longitudinal surface 25 or caddy that serves as structure for wiping excess paint from a brush. Thus, the painter need not use the rim of the paint container to remove excess paint from the brush. Any paint wiped from the brush naturally drains to the paint volume in the container.

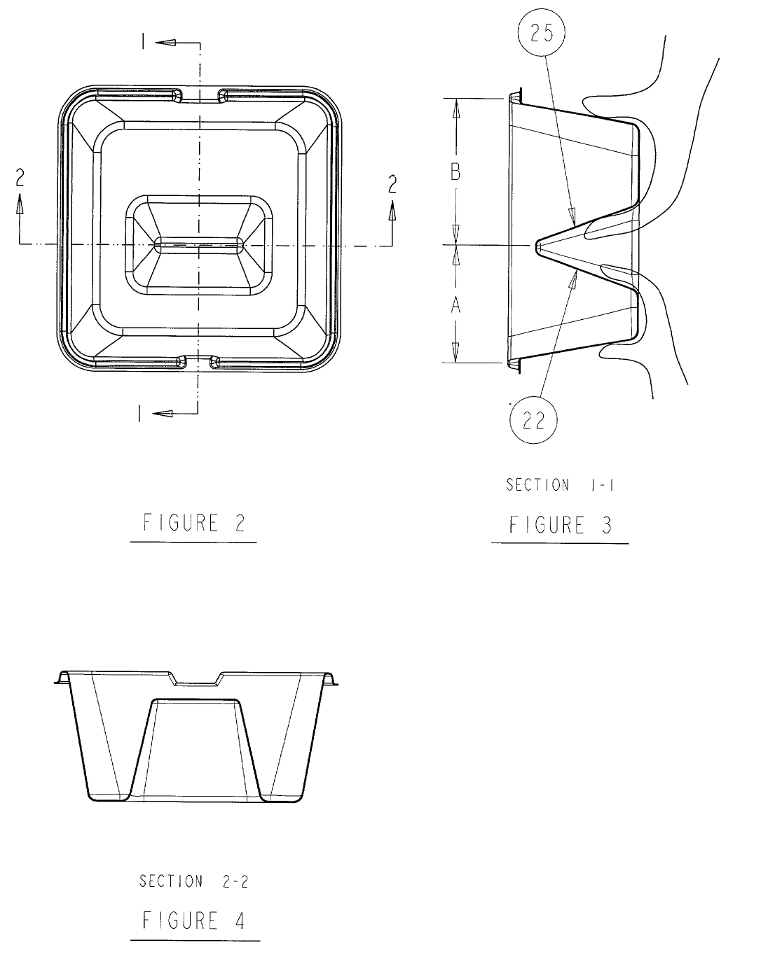

The longitudinal surface 25 also can serve as a caddy for a paint brush. When resting, the painter can rest the brush handle on the rim 15 and the brush portion on the caddy 25. For this reason, the longitudinal surface of the intermediate wall portion preferably is from about 0° to 20° below the level of the perimeter rim of the container, thus allowing any excess paint to drain from the brush to the bottom of the container rather than onto the paintbrush handle. Further, as shown in FIG. 3, the intermediate wall portion 22 and its proximal surface 25 may be offset from the opposing sides by different dimensions A and B, thus allowing the brush caddy 25 to accommodate a wider variation in brush sizes. The thin wall form of the intermediate wall portions 22 are also canted to allow for vertical stacking of paint containers. The rim of the container is further shown with (optional) notches 28a and 28b formed therein to receive the handle of a paint brush. The rim of the container is further adapted to cooperate with a snap-on cover, which will typically fit well since the rim will not be contaminated with spilt paint. The rim of the paint container is shown in a rectangular configuration, but it should be appreciated that round and other rim planforms fall within the scope of the invention.

As can be seen in FIG. 3, the phantom view of a human hand shows that the paint container of the invention is adapted to be gripped easily from the bottom with the fingers and thumbs on an exterior of the container and in the opposing recess formed at the exterior of the intermediate wall portions. This aspect of the invention provides for handling the inventive container somewhat as a true “painter” holds a palette when working. This method of holding the container offers true ergonomic advantages as the center of mass of the contained paint volume may be rested on the painter's palm. Further, as shown in FIG. 3, the intermediate wall portion 22 and its proximal surface 25 may be offset from the opposing sides by different dimensions A and B. Depending on the volume of paint and the size of the painter's hand, the painter may select which side of the container to grip for comfort and ergonomic reasons.

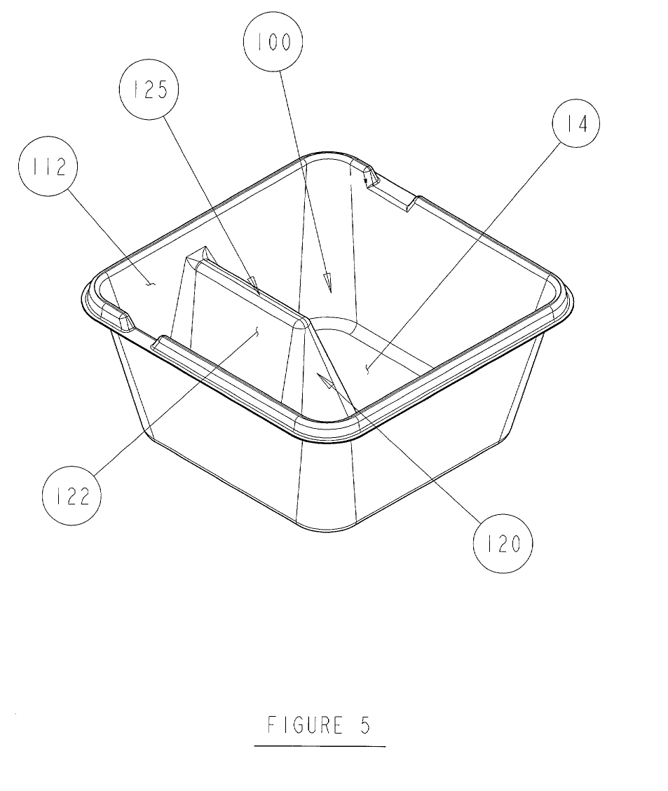

FIG. 5 illustrates an alternative embodiment 100 of paint container that carries an intermediate wall structure 120 that again serves as a brush caddy and wiping surface. In this embodiment, the intermediate wall portions 120 extend both upward from the bottom wall 14 and inward from the side wall 112. Otherwise, the caddy has a longitudinal surface 125 similar to that of the first-described embodiment. The thin walls of the intermediate wall portions 122 are also canted to allow for vertical stacking of paint containers.

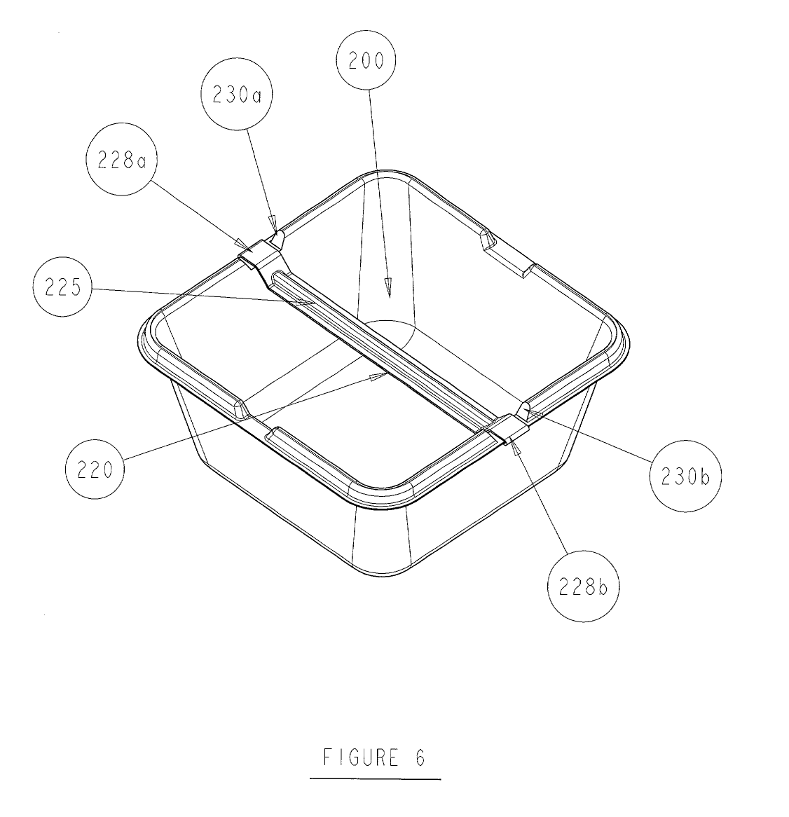

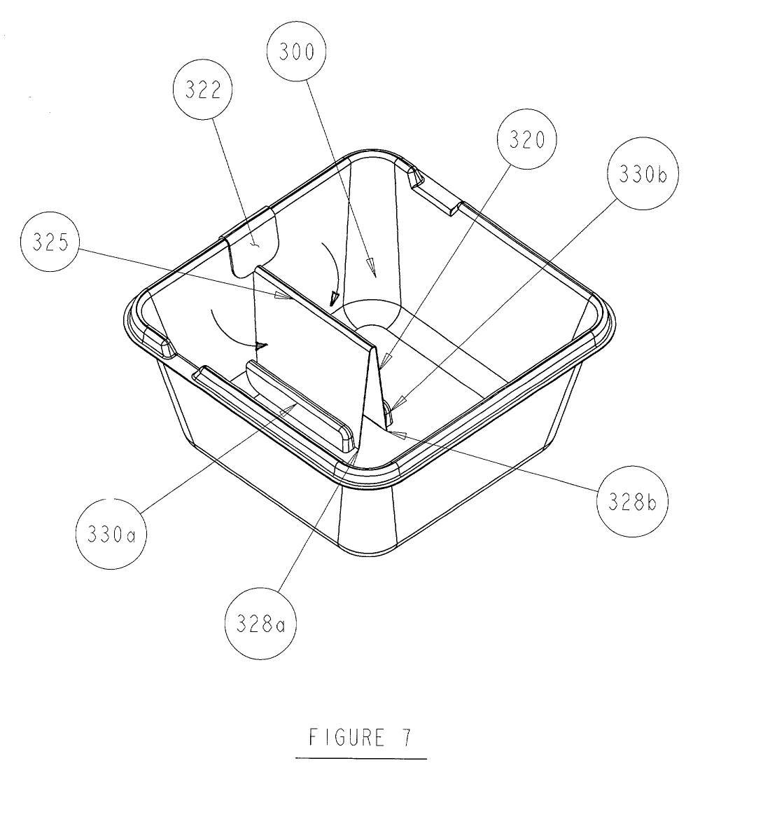

FIG. 6 shows another embodiment of container body 200 of the invention that provides an intermediate structure 220 or secondary body portion for serving as a brush caddy and brush wipe 225. In this embodiment, the secondary body portion 220 is detachable from the main body 200 by Page 2 a snap-type fit. Since an important feature of the invention is its ability to be stacked, the detachable secondary body portion 220 has a cross-sectional shape that allows it to clip to the rim 225 for shipping, storage and marketing. With the secondary body portion 220 clipped to the rim 225, the container will still stack vertically. As can be seen in FIG. 6, the ends 228a and 228b of the secondary body member 220 are adapted to snap-fit into cooperating recesses 230a and 230b in rim 225.

FIG. 7 illustrates an additional embodiment of container body 300 that provides an alternative intermediate structure 320 (secondary body portion) that serves as a brush caddy and brush wipe 325. In this embodiment, the secondary body portion 320 is attached to the main body 300 by a hinge-type bond indicated at 322. Again, an important feature of the invention is its ability to be stacked, and the secondary body portion 320 may be hinged and/or folded to lie flat against a side wall for storage. In use, the secondary body portion 320 can be hinged upwardly and then folded to insert edge portions 328a and 328b into cooperating recesses 330a and 330b in the walls thereof. Thus, caddy surface 325 will be provided as described above in the first embodiment.

Although particular embodiments of the present invention have been described above, it will be understood that this description is merely for purposes of illustration. Specific features of the invention are shown in some drawings and not in others, and this is for convenience only and any feature may be combined with another in accordance with the invention. Further variations will be apparent to one skilled in the art in light of this disclosure and are intended to fall within the scope of the appended claims.

What is claimed is:

1. A stackable paint bucket, comprising:
a vessel having a bottom wall, a side wall and an open top defining a perimeter therearound, the vessel defining an interior volume for carrying a liquid;
intermediate wall portions extending from the bottom or side wall that define an intermediate top surface portion that is intermediate to the perimeter of the open top, said intermediate surface serving as a brush wipe or brush caddy;
wherein the side wall, bottom wall and intermediate wall are substantially thin; and
wherein the side wall, bottom wall and intermediate wall are formed at a suitable angle to allow vertical stacking of identical vessels.

2. The paint bucket of claim 1, wherein said intermediate surface portion is from about 0° to 20° below said perimeter.

3. The paint bucket of claim 1 wherein said intermediate wall portion extends upward only from the bottom wall.

4. The paint bucket of claim 1 wherein said intermediate wall portion extends from the bottom wall and the side wall.

5. A paint bucket, comprising:
a vessel body with a bottom wall portion that transitions to a perimeter wall portion that defines an open top rim portion, the vessel body defining an interior volume for carrying a liquid;
an intermediate wall portion transitioning from the bottom or perimeter wall portions; and
wherein the intermediate wall portion has a top surface that is intermediate to the top rim portion.

6. The paint bucket of claim 5 wherein the bottom and side wall portions are formed at a suitable angle to allow vertical stacking of identical vessel bodies.

7. The paint bucket of claim 5, wherein the top surface of the intermediate wall portion is from about 0° to 20° below the top rim portion.

8. The paint bucket of claim 5 wherein the intermediate wall portions extend upward from the bottom wall.

9. The paint bucket of claim 5 wherein the intermediate wall portions extend from a side wall portion.

10. A stackable paint container, comprising:
(a) a first body portion comprising:
(i) a bottom wall,
(ii) side walls, and
(iii) an open top defining a perimeter rim portion;
(b) wherein the side walls are canted to allow vertical stacking of multiple first body portions; and
(c) a second body portion intermediate to the perimeter rim portion of the open top, the second body portion for serving as a brush wipe or brush caddy.

11. The paint container of claim 10 wherein the second body portion extends upwardly from the bottom wall.

12. The paint container of claim 10 wherein the second body portion extends outwardly from a side wall.

13. The paint container of claim 10 wherein the second body portion extends outwardly from a first location of the perimeter rim portion.

14. The paint container of claim 10 wherein the second body portion extends from a first location of the perimeter rim portion to a second location of the perimeter rim portion.

15. The paint container of claim 10 wherein the second body portion is hinged to a first location of said perimeter rim portion.

16. The paint container of claim 10 wherein the second body portion is foldable.

17. The paint container of claim 10 wherein the second body portion is detachable from first and second locations of said perimeter rim portion and clippable to said perimeter rim portion.
